(19) United States
(12) Patent Application Publication
(10) Pub. No.: US 2021/0124095 A1
(43) Pub. Date: Apr. 29, 2021

(54) THIN LENS OPTICAL MODULE, PARTICULARLY FOR AUTOFOCUS

(71) Applicant: OPTOTUNE CONSUMER AG, Dietikon (CH)

(72) Inventors: Manuel ASCHWANDEN, Allenwinden (CH); Stephan SMOLKA, Zürich (CH); Johannes HAASE, Dietikon (CH); Frank BOSE, Dietikon (CH); Christopher LANING, Windisch (CH); David Andreas NIEDERER, Küttigen (CH)

(73) Assignee: OPTOTUNE CONSUMER AG, Dietikon (CH)

(21) Appl. No.: 17/048,622

(22) PCT Filed: Apr. 23, 2019
(86) PCT No.: PCT/EP2019/060384

§ 371 Date: Oct. 19, 2020

(30) Foreign Application Priority Data
Apr. 19, 2018 (EP) 18168346.7
Sep. 10, 2018 (EP) 18193557.8

(51) Int. Cl. G02B 3/14; G02B 13/00

(52) U.S. Cl. CPC G02B 3/14; G02B 13/0075; G02B 13/0065

(57) ABSTRACT

The present invention relates to an optical device (1), comprising a lens (10) having an adjustable focal length, the lens (10) comprising a container (11) that encloses a lens volume (V) and a reservoir volume (R) that is connected to the lens volume (V), wherein the two volumes (R, V) are filled with a transparent liquid (L), wherein the container (11) further comprises a flat lateral wall structure (12) having a front side (12a) and a back side (12b), an elastically deformable and transparent membrane (20), a transparent cover element (30), and an elastically deformable wall portion (22), wherein the membrane (20) is connected to the back side (12b) of the lateral wall structure (12), wherein the cover element (30) is connected to the front side (12a) of the lateral wall structure (12) such that the lens volume (V) is arranged between the cover element (30) and the membrane (20), and wherein the wall portion (22) is arranged adjacent the reservoir volume (R), and wherein the wall portion (R) comprises an inside (22a) and an outside (22b) facing away from said inside (22a), wherein the inside (22a) contacts the liquid (L) residing in the reservoir volume (R), and wherein the lens (10) further comprises a lens shaper (40) that is connected to the membrane (20) and defines an area (21) of the membrane (20), which area (21) has an adjustable curvature and contacts the liquid (L) in the lens volume (V), and wherein the lens (10) further comprises a movable piston (50) connected to the outside (22b) of the wall portion (22) and configured to act on said outside (22b) to pump liquid (L) from the reservoir volume (R) into the lens volume (V) or from the lens volume (V) into the reservoir volume (R) so as to change the curvature of said area (21) of the membrane (20) and therewith the focal length of the lens (10).

The present invention relates to an optical device comprising a lens having an adjustable focal length.

Regarding such optical devices it is desirable to provide focus adjustable lenses that have a small installation space.

This problem is solved by an optical device having the features of claim 1.

Preferred embodiments of the present invention are stated in the respective sub claims and are described below.

According to claim 1 the optical zoom device comprises: a lens having an adjustable focal length, the lens comprising a container that encloses a lens volume and a reservoir volume that is connected to the lens volume, wherein the two volumes are filled with a transparent liquid, wherein the container further comprises a flat lateral wall structure having a front side and a back side (wherein particularly the front side faces away from the back side), an elastically deformable and transparent membrane, a transparent cover element, and an elastically deformable wall portion, wherein the membrane is connected to the back side of the lateral wall structure, and wherein the cover element is connected to the front side of the lateral wall structure such that the lens volume is arranged between the cover element and the membrane, and wherein the wall portion is arranged adjacent the reservoir volume, and wherein the wall portion comprises an inside and an outside facing away from said inside, wherein the inside contacts the liquid residing in the reservoir volume, and wherein the lens further comprises a lens shaper that is connected to the membrane and defines an area of the membrane, which area has an adjustable curvature and contacts the liquid in the lens volume, and wherein the lens further comprises a movable piston connected to the outside of the wall portion and configured to act on said outside to pump liquid from the reservoir volume into the lens volume or from the lens volume into the reservoir volume so as to change the curvature of said area of the membrane and therewith the focal length of the lens.

Particularly, the notion flat regarding the lateral wall structure means that the lateral wall structure comprises a thickness in a direction normal to the front side or the back side that is smaller than an extension of the lateral wall structure in a direction perpendicular to an optical axis of the lens. Particularly, the membrane and the cover element face each other in the direction of the optical axis of the lens. Particularly, the cover element and/or the membrane extend perpendicular to the optical axis.

Furthermore, particularly, the lens shaper is preferably fixed with respect to the container, i.e. it does not move with respect to the cover element or the lateral wall structure.

Particularly, the present invention allows providing a thin liquid lens that can include an actuator which can be based on a magnet and an electrical coil.

The approach according to the present invention is easily scalable to different clear apertures and allows minimizing the outer dimensions of the device in three directions (e.g. all directions not pointing in the actuator direction).

Particularly, the shape of the lens is advantageously customizable to maximize the possible camera display area of an electronic device (e.g. smart phone), e.g. by using an asymmetric actuator/pump configuration.

Furthermore, the container of the liquid lens can comprise a bent shape, particularly so as to adapt the container of the lens to a component of the optical device (such as a lens barrel) and to allow an arrangement of the container with respect to the component that minimized installation space. Corresponding embodiments will be explained in detail below.

Particularly, the present invention can be applied to a wide variety of different applications, such as
Autofocus in a mobile camera using a liquid lens by adding a minimum height
Macro in mobile phone cameras
Barcode scanning systems
Medical applications
Robot applications
Machine vision applications
Surveillance cameras
IOT devices
Drones

Particularly, the piston is movable to push against the outside of the wall portion to pump liquid from the reservoir volume into the lens volume or to pull on the outside to pump liquid from the lens volume into the reservoir volume. Due to the incompressibility of the liquid, pumping of liquid into the lens volume will increase a curvature of said area of the lens (starting with a flat area) and therewith the focal power while removing liquid from the lens volume into the reservoir volume will again decrease the curvature of said area. Thus, by pumping liquid between the two volumes, the curvature of said area of the membrane can be adjusted (e.g. from concave to convex or from flat to convex) so that the container forms a lens having an adjustable curvature. Thus, light passing through the container (e.g. through the cover element, the liquid in the lens volume and the membrane, is refracted according to the focal length defined by the curvature of said area of the membrane.

Particularly, according to an embodiment of the invention, the lateral wall structure comprises a plate member comprising a through-opening for accommodating at least a portion of the lens volume and an adjacent recess for accommodating at least a portion of the reservoir volume. Particularly this recess of the plate member can also be a (further) through-opening of the plate member.

Further, according to an embodiment of the invention, the lens shaper comprises a through-opening delimited by a circular edge that contacts the membrane to define said area of the membrane.

According to an embodiment of the invention, the membrane is arranged between the plate member and the lens shaper. Here, particularly, the lens shaper can be formed by a further plate member, wherein the lens shaper (further plate member) comprises said through-opening delimited by said circular edge, as well as a further through-opening configured to expose said wall portion on which the piston acts. Alternatively, the lens shaper can be formed by a ring member.

Further, according to an alternative embodiment of the invention, the membrane is connected to the plate member via the lens shaper, so that the lens shaper is arranged between the membrane and the plate member. Here, particularly, the lens shaper can be formed by further plate member, wherein the through-opening of the lens shaper that is delimited by said circular edge of the lens shaper accommodates a portion of the lens volume, and wherein the lens shaper (further plate member) comprises a further through-opening for accommodating a portion of the reservoir volume.

According to a further alternative embodiment, the lens shaper is formed by the plate member itself, wherein the circular edge of the lens shaper is formed by a circular edge of said through-opening of the plate member.

Furthermore, according to an embodiment of the present invention, the plate member is a printed circuit board, wherein said circular edge is formed by an etched metal layer (e.g. metal formed by or comprising copper) of the printed circuit board.

Alternatively, the lateral wall structure of the plate member or the further plate member can be formed out of or can comprise: a metal, a plastic material, a polymer. Particularly, the lateral wall structure or the plate member or the further plate member can be an injection molded part.

Further, according to an embodiment of the invention, the cover element is connected to the plate member so that the cover element covers the through-opening of the plate member and/or the recess of the plate member.

According to a further embodiment, a further membrane is arranged between the plate member and the cover element. The further membrane can cover the through-opening and/or the recess of plate member. Particularly, the further membrane can be adapted to improve index matching between the liquid and cover element of the lens.

Furthermore, according to an embodiment, the cover element can be formed out of or can comprise one of the following materials: a glass, a plastic material, a polymer.

Further, according to an embodiment of the invention, the reservoir volume is arranged opposite the lens volume in a direction perpendicular to the optical axis of the lens. Thus, particularly, the arrangement of the reservoir volume with regard to the lens volume is asymmetric with respect to the optical axis. Particularly, this allows one to place the lens volume portion of the container that particularly comprises a comparatively small height in the direction of the optical axis on top of a lens barrel (which adds only a small height to the installation height of the lens barrel), while the bulkier part (e.g. the reservoir volume portion of the container including the piston connected to the outside of said wall portion on which the piston acts) can be arranged laterally with respect to the lens barrel.

According to a preferred embodiment, said wall portion to which the piston is connected, is formed by a portion of the membrane of the lens, which in this case preferably covers the whole back side of the lateral wall structure or plate member.

Furthermore, according to yet another embodiment, the container comprises a first portion surrounding the lens volume and a second portion surrounding the reservoir volume, wherein the first portion encloses an obtuse angle with the second portion (i.e. said angle is larger than 90° and smaller than 180°. Also here, the reservoir portion of the container, due to extending at an angle with respect to the lens volume portion of the container, can be arranged laterally with respect to the lens barrel, when the container is arranged on a face side of the lens barrel.

Furthermore, according to an embodiment of the present invention, the optical device comprises a lens barrel, wherein the lens barrel extends around an internal space of the lens barrel, wherein the lens barrel further comprises a plurality of rigid lenses arranged on top of one another in said internal space, and wherein the lens barrel comprises a face side that delimits an opening via which light can enter the internal space of the lens barrel to pass through the rigid lenses, and wherein the face side is connected to a lateral outer surface of the lens barrel, which lateral outer surface extends around the internal space.

Furthermore, the optical device can comprise an optical image sensor that can be arranged in the internal space of the lens barrel or in front of the lens barrel such that the rigid lenses face the image sensor and light entering said opening of the lens barrel along an optical axis of the lens barrel (i.e. of the rigid lenses therein) can pass through the rigid lenses to impinge on the optical image sensor.

Further, according to an embodiment of the invention, the lens further comprises a housing connected to the container of the lens such that the housing encloses the piston together with the container.

Particularly, according to an embodiment, the container and/or the housing are connected to the lens barrel, such that the container is arranged on the face side of the lens barrel and the lens volume faces the rigid lenses of the lens barrel, and such that the piston faces the lateral surface of the lens barrel in a direction perpendicular to the optical axis of the lens (or of the lens barrel). Further, particularly, the housing of the piston is arranged on the lateral surface of the lens barrel.

Furthermore, according to an embodiment, the container and/or the housing are glued to the lens barrel.

Further, according to an embodiment of the present invention, the container and/or the housing are arranged (or connected) to the lens barrel in a form fitting manner.

Furthermore, in an embodiment, the container forms a stop of the piston in a first movement direction of the piston in which the piston pushes against the outside of the wall portion. Furthermore, particularly, enclosing the piston with the housing allows to provide a stop for the piston in a second movement direction of the piston in which the piston pulls at the outside of the wall portion. According to a further embodiment, the housing can also form a stop for the piston in a direction perpendicular to said movement directions. Thus, the housing and/or the container of the lens help to limit a movement of the magnet (e.g. due to a mechanical shock) which improves protection of the membrane/wall portion to which the magnet is connected and which supports the magnet.

Further, according to an alternative embodiment of the present invention, instead of providing a separate housing for the piston, the face side of the lens barrel can comprises a recess for receiving the piston, wherein the container is now connected (particularly glued) to the face side of the lens barrel such that the lens volume faces the rigid lenses of the lens barrel and such that the piston protrudes from the outside of the wall portion into the recess of the face side of the lens barrel. Here, the lens barrel itself provide a housing for the piston.

Also here, particularly, the bottom of the recess or a printed circuit board arranged thereon can form a stop for the piston in the second movement direction of the piston in which the piston pulls at the outside of the wall portion. Further, an inner side of the recess can form a stop for the piston in a direction perpendicular to the first and second movement direction of the piston. Furthermore, also here, the container can form a stop for the piston in the first movement direction of the piston in which the piston pushes against the outside of the wall portion.

Further, according to an embodiment of the invention, the housing of the piston (or the recess of the lens barrel) comprises an air duct connecting an internal space of the housing (or of the recess) in which the piston is arranged to an outside of the housing (or of the lens barrel) to allow venting of the internal space (or recess of the lens barrel).

Further, according to an embodiment of the invention, the housing (or recess of the lens barrel) comprises a further air duct connecting the internal space of the housing (or of the recess) with the internal space of the lens barrel to allow venting of the internal space of the lens barrel. Alternatively (or in addition) the optical device can comprises a further air duct connecting the internal space of the lens barrel to an outside of the lens barrel.

Instead of providing an installation space saving connection of the lens to a lens barrel, the lens can also be connected in an advantageous manner to other optical components such as a folding prism. Here, the container of the lens can be connected (particularly glued) to a surface of the folding prism. Particularly, the container is connected such to said surface the folding prism that the membrane of the lens is arranged between said surface of the folding prism and the cover element of the lens. Also here, the optical device can comprise a lens barrel as described above, wherein the lens barrel is now preferably arranged in an optical path of the optical device between the folding prism and an optical image sensor of the optical device. Particularly, the lens barrel can be configured to move with respect to the image sensor so as to provide autofocus and/or optical image stabilization. However, also in such a configuration, the lens can perform an autofocus function, and is particularly also capable to generate macro shots.

Further, according to an embodiment of the invention, the optical device comprises an actuator, wherein the actuator is configured to move the piston such that the piston pushes against the outside of the wall portion to pump liquid from the reservoir volume into the lens volume so as to change the curvature of said area of the membrane (e.g. from flat to convex) and therewith the focal length of the lens, and/or wherein the actuator is configured to move the piston such that the piston pulls at the outside of the wall portion to pump liquid from the lens volume into the reservoir volume so as to change the curvature of said area of the membrane (e.g. from convex to less convex or flat) and therewith the focal length of the lens.

Further, according to an embodiment of the invention, the piston comprises a magnet, wherein the magnet particularly forms a component of the actuator.

Further, according to an embodiment of the invention, the magnet is connected to the outside of the wall portion via a spacer.

Further, according to an embodiment of the invention, the actuator comprises an electrically conducting coil configured to interact with the magnet to move the piston when an electrical current flows through the coil, wherein particularly the movement direction of the piston, e.g. towards the outside of the wall portion to push against the outside of the wall portion (first movement direction) or away from the outside to pull at the outside of the wall portion (second movement direction), depends on the direction of the current flowing through the coil (for a given orientation of the magnetization of the magnet). Particularly, the optical device can comprise a driver circuit to control said electrical current.

Further, according to an embodiment of the invention, the coil comprises an electrical conductor which comprises windings that extend around an (e.g. virtual) winding axis, wherein particularly, the winding axis extends parallel to the optical axis of the lens and/or normal to the wall portion of the container.

Particularly, according to an embodiment, the coil faces the magnet in the direction of the winding axis, wherein the magnetization of the magnet extends parallel to the winding axis. Alternatively, the magnet can also be arranged such that the magnet is at least partially arranged in a space (e.g. air gap) surrounded by the windings of the coil. Also here, the magnet can comprise a magnetization that extends parallel to the winding axis. Furthermore, alternatively, in case the magnet is at least partially arranged in said space or is completely arranged in said space that is surrounded by the windings of the coil, the magnet can be a ring magnet that is radially polarized, i.e. comprises a magnetization extending in a radial direction of the ring magnet. Here, particularly, the magnetization extends perpendicular to the winding axis.

Further, according to an embodiment of the invention, the coil is integrated into the plate member and particularly extends along a boundary of the recess of the plate member that accommodates the reservoir volume, wherein particularly the magnet faces the coil in the first movement direction, and wherein particularly the magnet comprises a magnetization that extends parallel to the winding axis of the coil.

Further, according to an embodiment, the magnetization can extend parallel to the first or second movement direction of the piston and/or parallel to the optical axis of the lens.

Further, according to an embodiment of the invention, the coil is one of: integrated into a printed circuit board that is arranged on a bottom of the recess of the face side of the lens barrel (see above), arranged on a bottom of the recess of the face side of the lens barrel, integrated into a bottom of the recess of the face side of the lens barrel. Particularly, the magnet can face the coil in the second movement direction of the piston. Furthermore, particularly, the magnet can comprise a magnetization that extends parallel to the winding axis. Further, particularly, the printed circuit board comprising the coil can be connected via a flexible conductor to a further (e.g. flexible) connector configured to provide electrical contact to the optical device, particularly to provide electrical contact to the image sensor and to the lens (e.g. to the actuator of the lens).

Further, according to an embodiment of the invention, the lens barrel comprises an electrical connector molded into the lens barrel, wherein the electrical connector protrudes out of the lens barrel with two first end sections that are soldered to the coil, and wherein particularly the electrical connector protrudes out of the lens barrel with two second end sections that form solderable electrical contacts.

Further, according to an embodiment of the invention, the housing of the piston comprises a bottom facing the wall portion, and a lateral wall connecting the bottom of the housing to the container of the lens.

Further, according to an embodiment of the invention, the coil is integrated into the bottom of the housing or arranged on the bottom of the housing, such that the magnet faces the coil in the second movement direction of the piston. Here, the magnet can comprise a magnetization that extends parallel to the winding axis of the coil.

Further, according to an embodiment of the invention, the coil is integrated into the lateral wall of the housing or is arranged on the lateral wall of the housing, wherein particularly the magnet is at least partially or completely arranged in a space (e.g. air gap) surrounded by the windings of the coil. Here, particularly, the magnet can comprise a magnetization that extends parallel to the winding axis (axially polarized) or perpendicular to the winding axis (radially polarized).

Further, according to an embodiment of the invention, the actuator comprises a member formed out of a shape memory alloy for moving the piston, which member particularly connects the piston to said housing of the piston or to the lens barrel, wherein particularly said member comprise a state in which the member causes the piston to pull at the outside of the wall portion. The actuator may also comprise a plurality of shape memory alloy members to allow a push/pull operation regarding the piston structure.

In the following, further features as well as embodiments of the present invention are described with reference to the Figures that are appended to the claims, wherein:

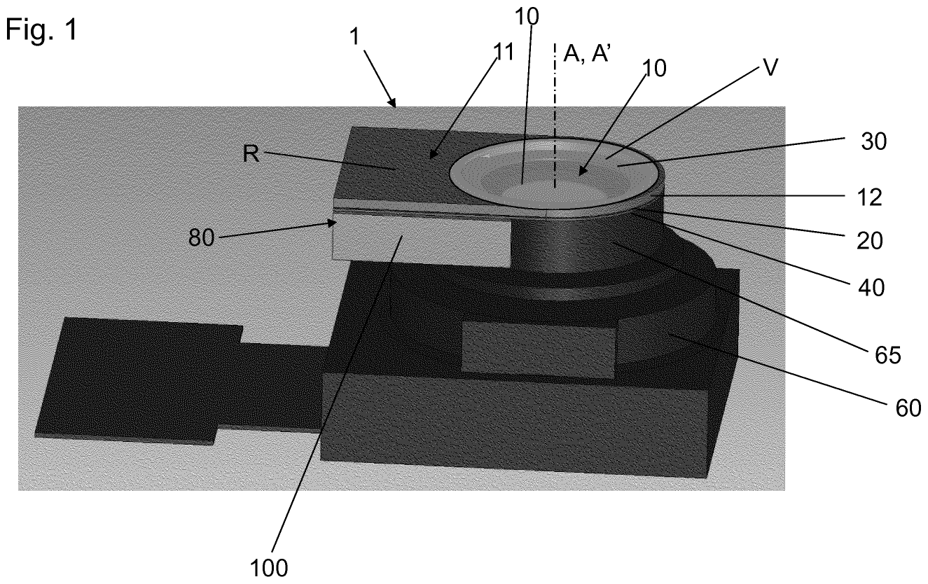

FIG. 1 shows a perspective view of an embodiment of an optical device according to the present invention, wherein the optical device comprises a lens barrel and a liquid lens having an adjustable focal length, wherein the lens comprises a reservoir volume for the liquid that is asymmetrically arranged with respect to the common optical axes of the lens and the lens barrel;

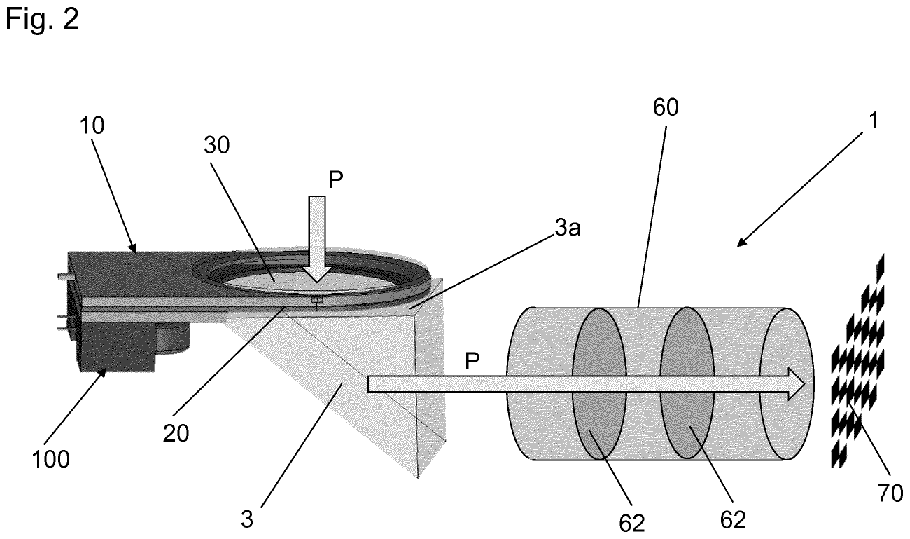

FIG. 2 shows a further embodiment of an optical device according to the present invention, wherein the lens is arranged on a folding prism of the optical device;

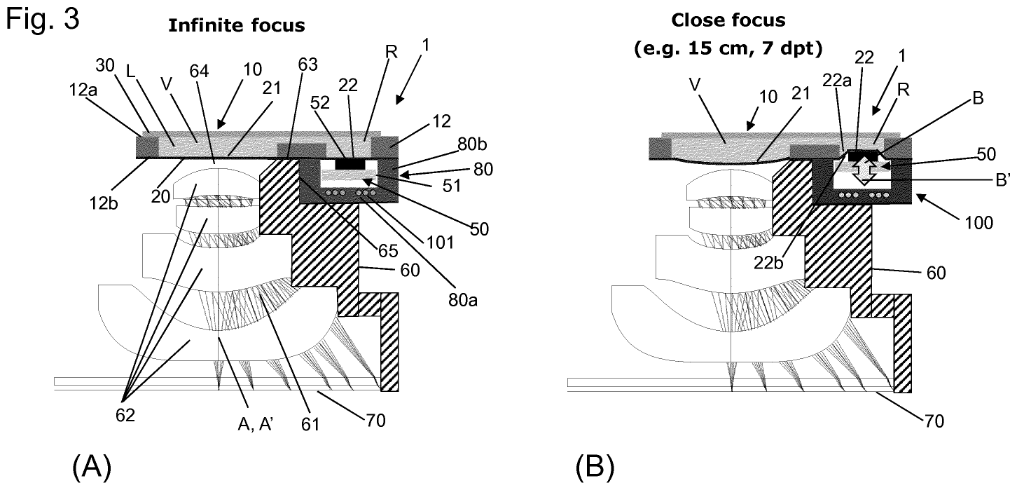

FIG. 3 shows a cross sectional view of an embodiment of an optical device to illustrate adjustment of the focal length of the lens, wherein (A) shows the infinite focus configuration, and (B) shows a configuration where the optical active area of the membrane is forced to assume a convex curvature by pumping liquid from the reservoir volume into the lens volume;

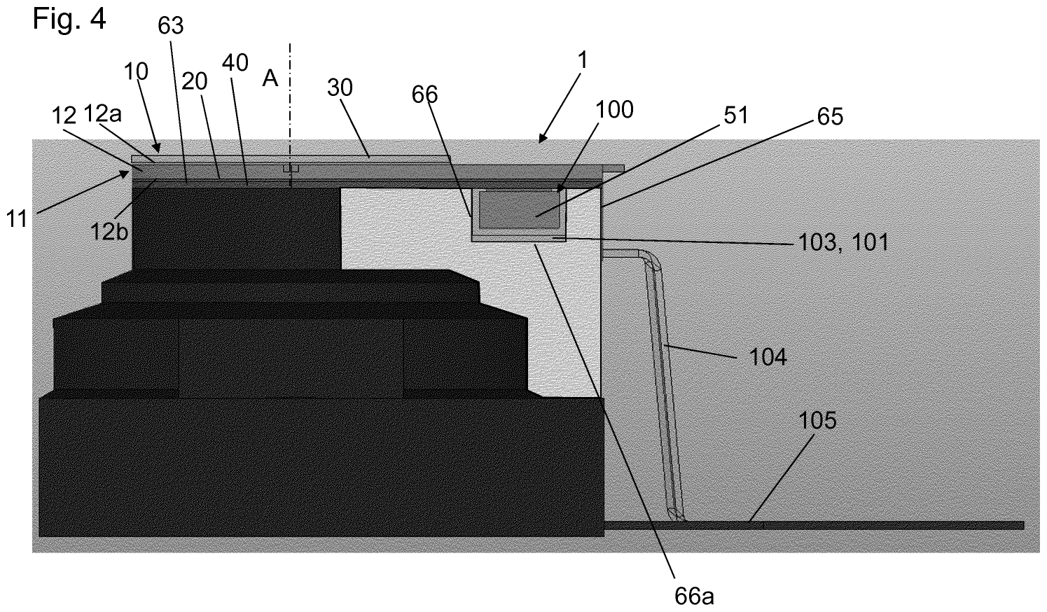

FIG. 4 shows a partially cross sectional view of a further embodiment of an optical device according to the present invention, wherein here the lens barrel itself forms a housing for receiving the piston;

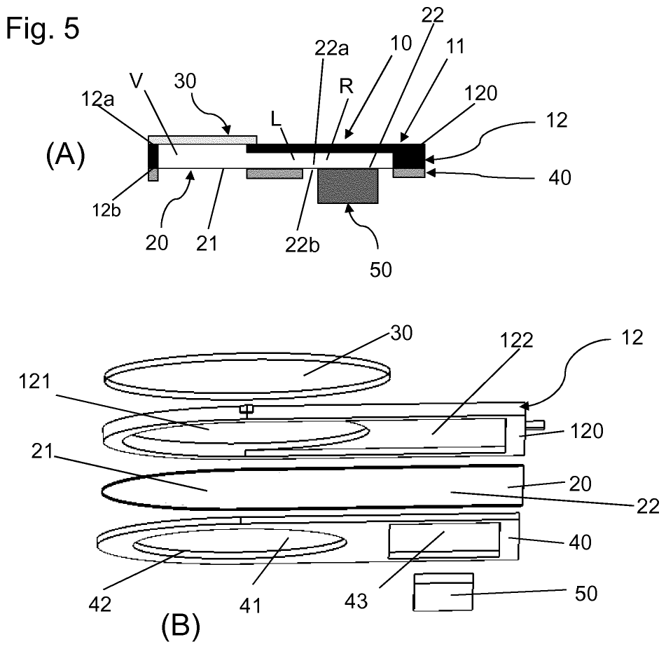

FIG. 5 shows a schematical cross sectional view (A) and an exploded view (B) of an embodiment of a lens of an optical device according to the present invention;

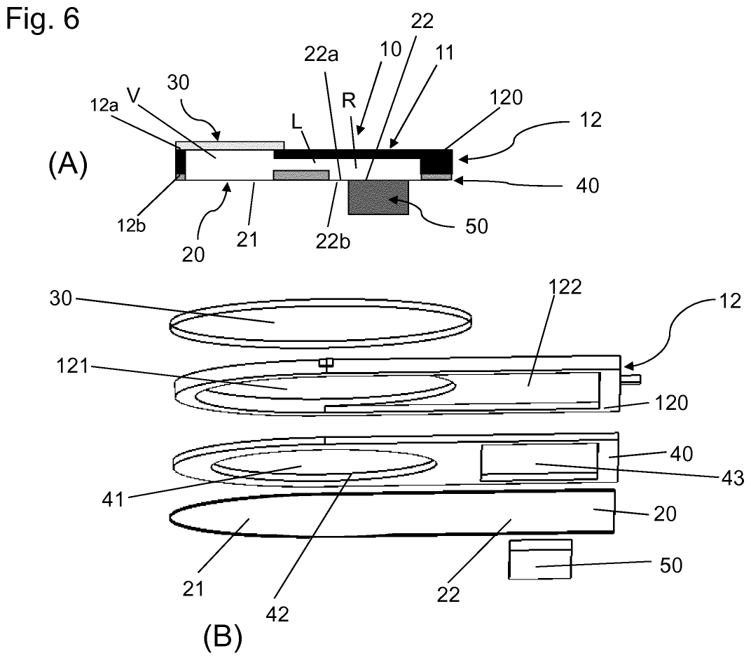

FIG. 6 shows a schematical cross sectional view (A) and an exploded view (B) of a further embodiment of a lens of an optical device according to the present invention;

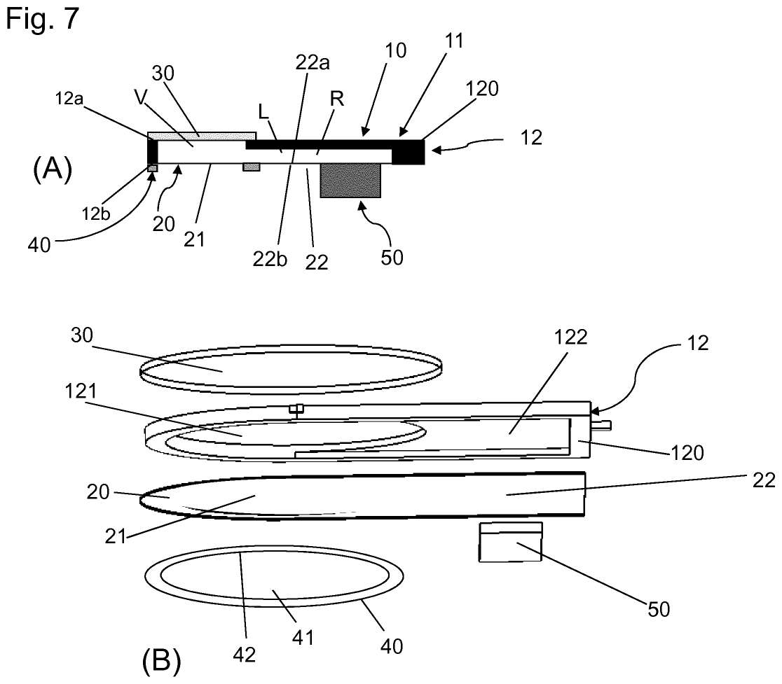

FIG. 7 shows a schematical cross sectional view (A) and an exploded view (B) of a further embodiment of a lens of an optical device according to the present invention.

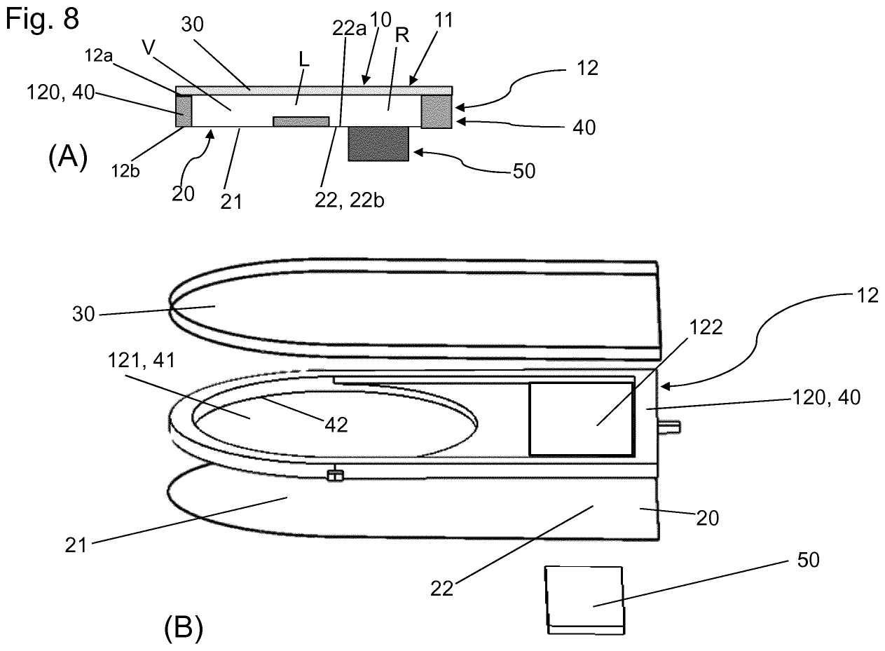

FIG. 8 shows a schematical cross sectional view (A) and an exploded view (B) of a further embodiment of a lens of an optical device according to the present invention;

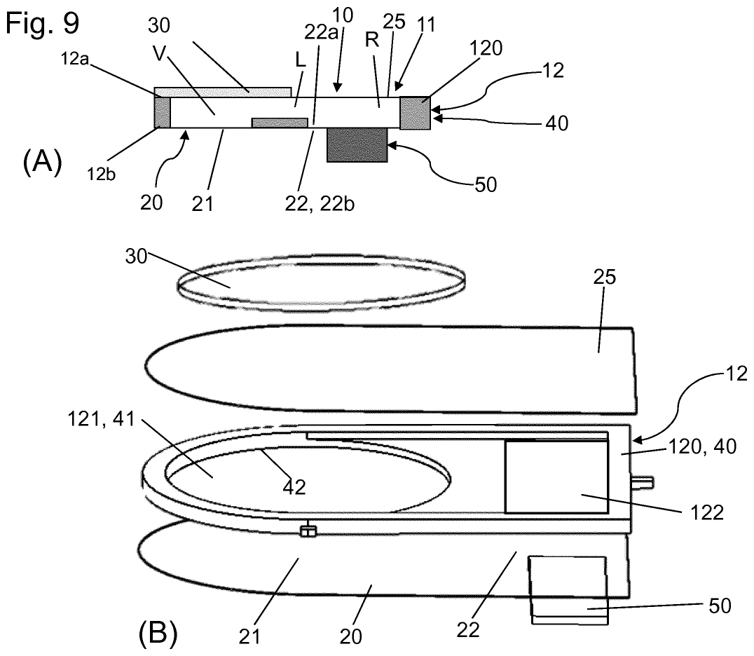

FIG. 9 shows a schematical cross sectional view (A) and an exploded view (B) of a further embodiment of a lens of an optical device according to the present invention;

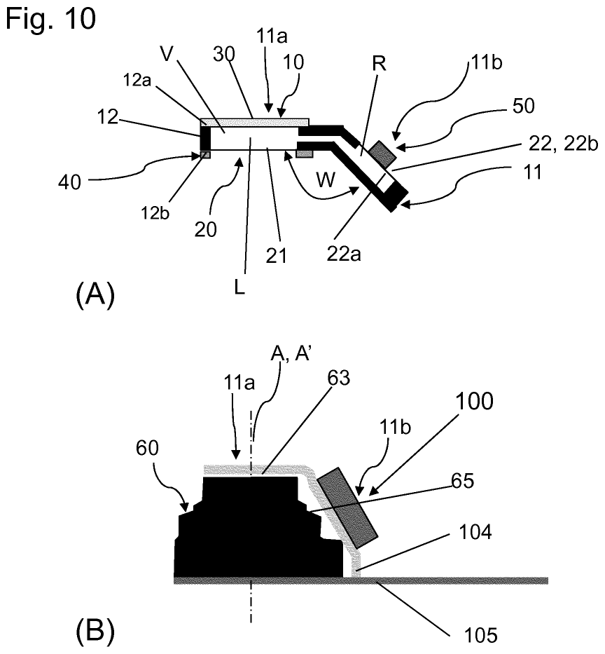

FIG. 10 shows a schematical cross sectional view (A) of a further embodiment of a lens of an optical device according to the present invention, wherein the lens comprises an angled housing, and wherein (B) shows an arrangement of the lens with respect to a lens barrel of the optical device;

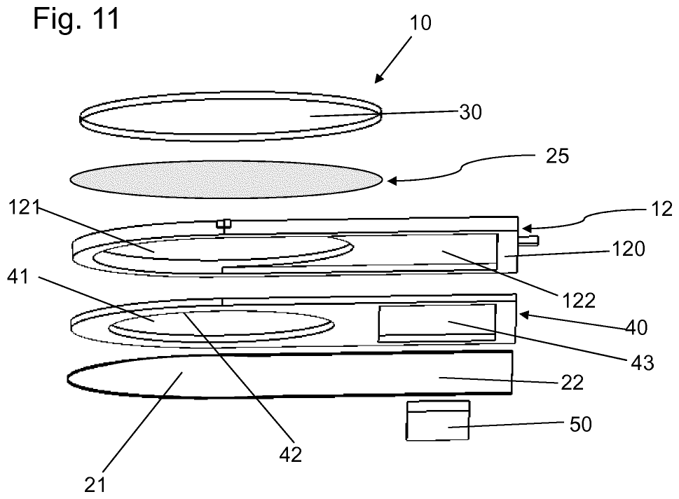

FIG. 11 shows a schematical cross sectional view a further embodiment of a lens of an optical device according to the present invention, wherein an additional membrane is arranged between a cover element and the lens volume comprising the liquid of the lens, wherein the further membrane serves for matching the refractive index of the liquid and the cover element (e.g. glass);

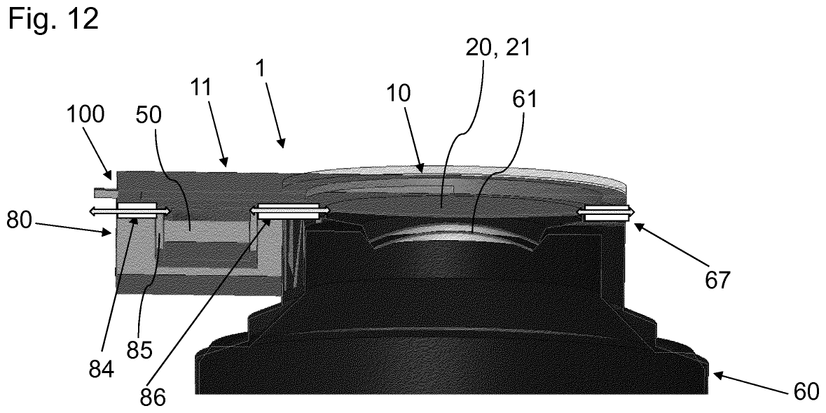

FIG. 12 shows a cross sectional view of an embodiment of an optical device according to the present invention, wherein the device comprises air ducts for venting the internal spaces of the housing of the piston and the lens barrel;

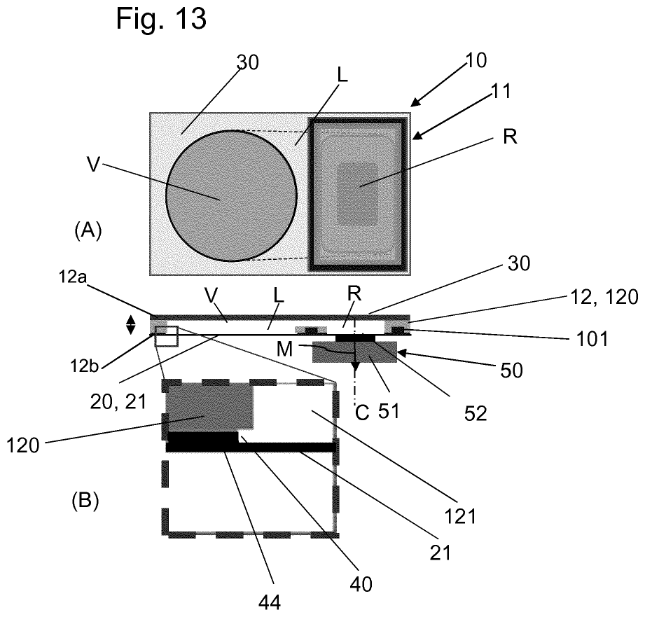

FIG. 13 shows a schematical cross sectional view (A) and an exploded view (B) of a further embodiment of a lens of an optical device according to the present invention, wherein the plate member forming the lateral wall of the container of the lens is a printed circuit board with an integrated coil of the actuator of the lens;

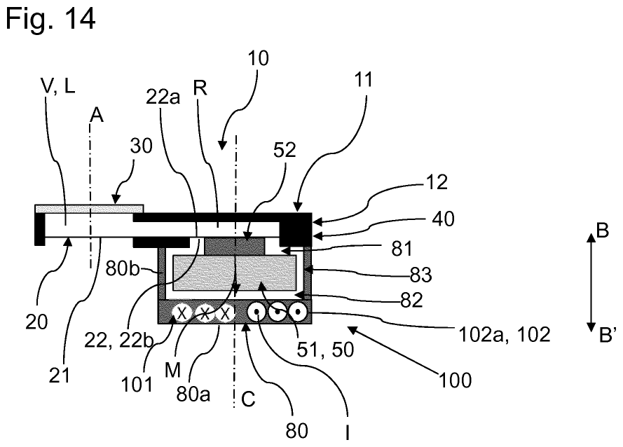

FIG. 14 shows a schematical cross sectional view an embodiment of a lens of an optical device according to the present invention, wherein the actuator of the lens comprises a coil facing an axially polarized magnet;

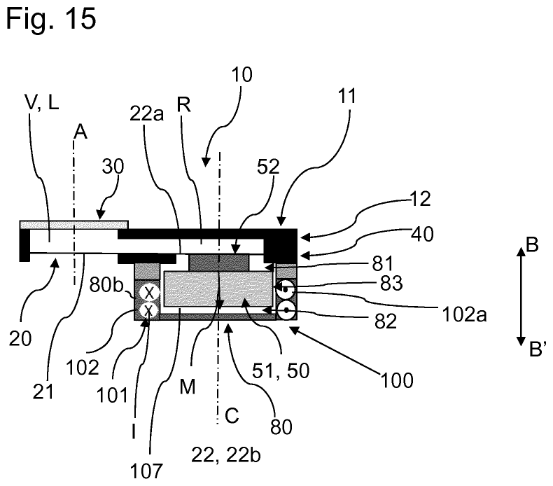

FIG. 15 shows a schematical cross sectional view a further embodiment of a lens of an optical device according to the present invention, wherein the actuator of the lens comprises a magnet dipping into the coil of the actuator, wherein the magnet is axially polarized;

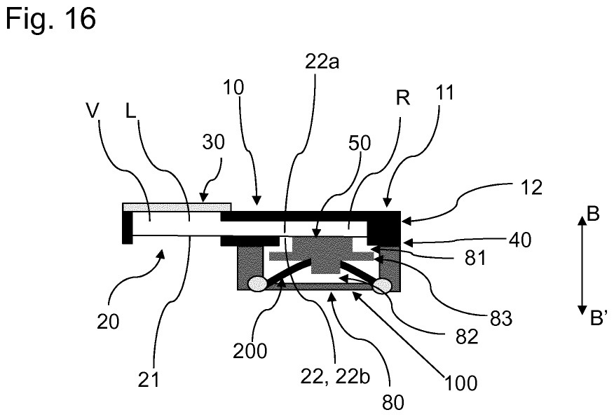

FIG. 16 shows a schematical cross sectional view a further embodiment of a lens of an optical device according to the present invention, wherein the actuator of the lens comprises a shape memory alloy member to move the piston of the lens;

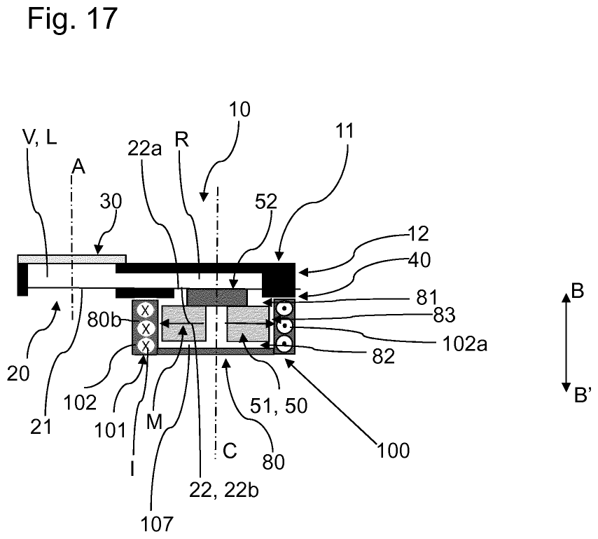

FIG. 17 shows a schematical cross sectional view a further embodiment of a lens of an optical device according to the present invention, wherein the actuator of the lens comprises a magnet dipping into the coil of the actuator, wherein the magnet is radially polarized;

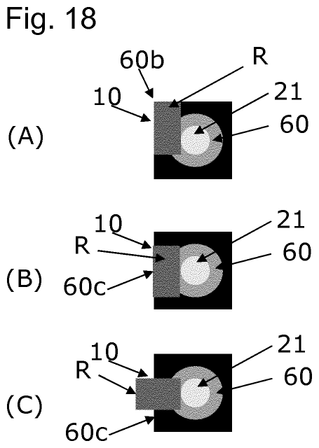

FIG. 18 illustrates different possibility of an asymmetric arrangement of the reservoir volume on the lens barrel with respect to the optically active area of the lens, wherein the in (A) a configuration is shown where the reservoir volume is arranged on a corner region of the lens barrel, while (B) shows a configuration where the reservoir volume is arranged on an edge of the lens barrel in a centered fashion. Further, (C) shows a configuration where the reservoir volume is arranged on the edge of the lens barrel but protrudes past the edge from the lens barrel;

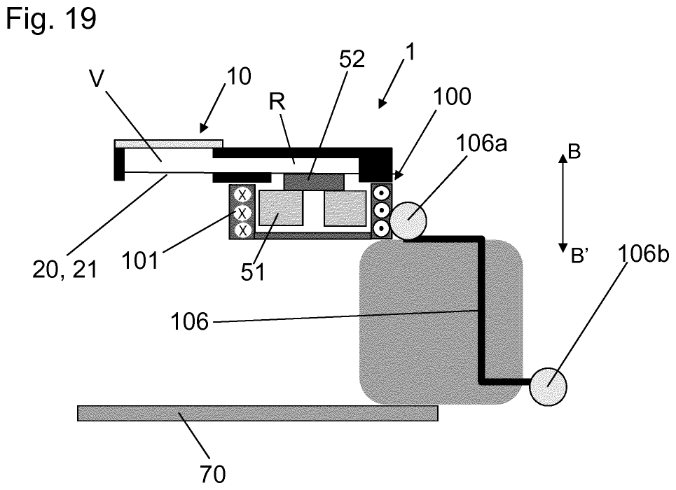

FIG. 19 shows a schematical cross sectional view of an embodiment of an optical device according to the present invention comprising a connector that is integrated into the lens barrel, particularly by way of insert molding; and

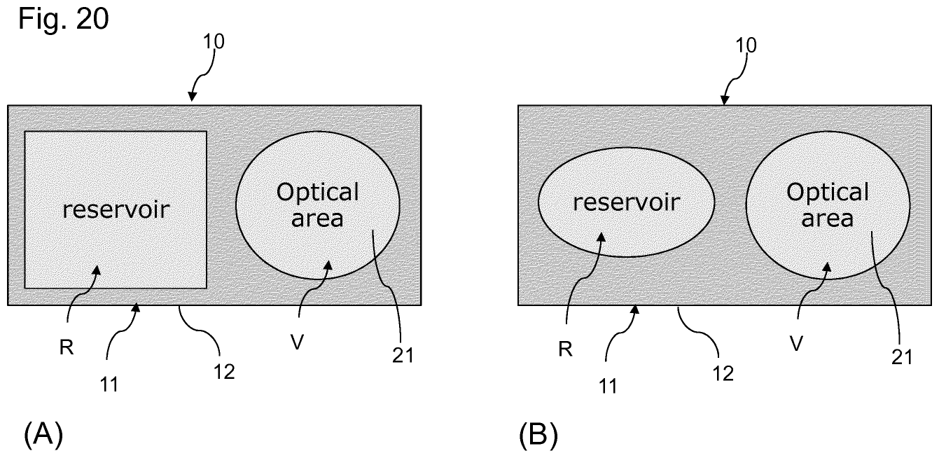

FIG. 20 shows different possible shapes of the reservoir and lens volume, wherein preferably the lens volume comprises a circular cross section (A), (B), while the reservoir volume can deviate from a circular shape, i.e. square (A) or elliptical (B).

The present invention relates to an optical device 1, e.g. a camera, as shown e.g. in FIGS. 1 to 4. Particularly, the optical device 1, comprises a lens having an adjustable focal length, wherein the lens 10 comprises a container 11 that encloses a lens volume V and a reservoir volume R that is connected to the lens volume V. The two volumes R, V are filled with a transparent liquid L. The container 11 further comprises a flat lateral wall structure 12 that comprises a front side 12a and a back side 12b, an elastically deformable and transparent membrane 20, a transparent cover element 30, and an elastically deformable wall portion 22 (cf. e.g. FIG. 3), wherein the membrane 20 is connected to the back side 12b of the lateral wall structure 12, and wherein the cover element 30 is connected to the front side 12a of the lateral wall structure 12 such that the lens volume V is arranged between the cover element 30 and the membrane 20. Light can therefore pass through the cover element 30, the lens volume V that is filled with the transparent liquid L and the membrane 20. By changing a curvature of an area 21 of the membrane 20 adjacent the lens volume V, the focal length of the lens 10 can be adjusted, which will be explained in detail below.

Further, said wall portion 22 is arranged adjacent the reservoir volume R, wherein the wall portion R comprises an inside 22a and an outside 22b facing away from said inside 22a, wherein the inside 22a contacts the liquid L residing in the reservoir volume R (cf. e.g. FIG. 3).

To assure that the membrane 20 develops a defined, precise curvature, the lens 10 further comprises a lens shaper 40 that is connected to the membrane 20 and defines an e.g. circular area 21 of the membrane 20, which area 21 has an adjustable curvature and contacts the liquid L in the lens volume V. For adjusting this curvature and therewith the focal length of the lens 10, the lens 10 further comprises a movable piston 50 connected to the outside 22b of the wall portion 22 and configured to act on said outside 22b to pump liquid L from the reservoir volume R into the lens volume V or vice versa. Preferably, the wall portion 22 is formed by a portion of the membrane 20. Particularly, the piston 50 can be enclosed by a housing 80 connected to the container 11 of the lens 10 (cf. e.g. FIGS. 1 and 3)

Adjustment of the focal length of the lens 10 is exemplary illustrated e.g. in FIG. 3 which shows the working principle for a camera autofocus function. Here, the curvature of said area 21 is changed from a flat state shown in FIG. 3(A) to a convex state shown in FIG. 3(B) by pumping liquid L from the reservoir volume R into the lens volume V so that the liquid L in the lens volume V presses against said area 21 which then develops a convex curvature. Consequently, in case the piston pulls at the portion 22 of the membrane 20, liquid L is pumped back into the reservoir volume R and the curvature of the area 21 can be reduced back to the flat state. Due to the fact that the piston can be continuously moved in the opposite movement direction B, B′, i.e. towards and away from the outside 22b of said portion 22 of the membrane 20, the focal length can be adjusted in a continuous fashion over a certain range, e.g. given by the piston stroke, piston area and also optical lens area.

As indicated in FIGS. 1 and 3, the container 11 of the lens is particularly adapted to be arranged on a lens barrel 60 in an installation space saving manner. Particularly, such a lens barrel 60 extends in circumferential fashion and surrounds an internal space 61 in which a plurality of rigid lenses 62 are arranged on top of one another. Furthermore, the lens barrel 60 comprises a face side 63 that delimits an opening 64 via which light can enter the internal space 61 of the lens barrel 60 to pass through the rigid lenses 62. Furthermore, the lens barrel 60 comprises a lateral outer surface 65 extending around the internal space 61.

The lens barrel 60 deflects light that passes the lens barrel 60 along an optical axis A′ of the lens barrel 60 onto an image sensor 70 of the optical device (e.g. camera), wherein the lens 10 (e.g. adjustment of the focal length) can be driven by an optical autofocus feedback signal provided by the image sensor 70.

Particularly, as indicated in FIGS. 1 and 3 the reservoir volume R is arranged opposite the lens volume V in a direction perpendicular to the optical axis A of the lens 10.

Generally, the container 10 can comprise a relatively small height in the direction of the optical axis A of the lens L while the portion comprising the reservoir volume R and piston 50 connected to the membrane portion 22 demands a larger installation space in said height direction (along the optical axis A).

However, the design of the container 11 of the lens 10 allows an asymmetrical arrangement of the container 11/reservoir volume R with regard to the optical axis A, so that only a small height that can be smaller than 0.5 mm is added to the lens barrel 60. Particularly, the asymmetric arrangement of the container 11 allows to move the lens to an edge of a display of a mobile phone.

Particularly, as shown in FIGS. 1 and 3, the container 11 and the housing 80 are preferably mounted, particularly glued, to the lens barrel 60, such that the container 11 is arranged on the face side 63 of the lens barrel 60, wherein the lens volume V faces the rigid lenses 62 of the lens barrel 60, and such that the piston 50 and the housing 80 faces the lateral outer surface 65 of the lens barrel 60 in a direction perpendicular to the optical axis A of the lens 10 (or perpendicular to the optical axis A′ of the lens barrel 60 which coincides with the optical axis A). Further, particularly, the housing 80 of the piston 50 is arranged on the lateral outer surface 65 of the lens barrel 60 in a form fitting manner.

Apart from an arrangement of the lens 10 on a lens barrel, the asymmetric arrangement can also be used in conjunction with other optical components such as a folding prism 3 which is shown in FIG. 3. According to this embodiment, the container 11 is connected, particularly glued, to a surface 3a of the folding prism 3, such that the membrane 20 of the lens 10 is arranged between the surface 3a of the folding prism 3 and the cover element 30 of the lens 10. The housing 80/piston 50 can be arranged laterally with respect to the prism, to save installation space in the height direction.

Also here, the optical device 1 can comprise a lens barrel 60 (see above), wherein the lens barrel 60 is now preferably arranged in an optical path P of the optical device 1 between the folding prism 3 and an optical image sensor 70 of the optical device 1. Particularly, the lens barrel 60 can be configured to move with respect to the image sensor 70 so as to provide autofocus and/or optical image stabilization. However, also the lens 10 can provide autofocus and macro.

FIG. 4 shows a further a further embodiment of the optical device 1 according to the invention that allows to omit the additional housing 80 for enclosing the piston 50.

Here, a recess 66 is formed in the face side 63 of the lens barrel 60 for receiving the piston 50, wherein the container 11 of the lens 10 is connected, particularly glued, to the face side 63 of the lens barrel 60 such that the lens volume V faces the rigid lenses 62 of the lens barrel 60 and such that the piston 50 protrudes from the outside 22b of the wall portion 22 into the recess 66. Thus, in this embodiment, a housing for enclosing the piston 50 is formed by the lens barrel 60.

Particularly, to achieve such a configuration, an outer shape of the lens barrel 60 is adapted to accommodate space for the actuator, particularly to provide a cavity for the piston 50. Furthermore, a coil 101 for moving the piston 50 can be integrated into a printed circuit board (PCB) 103 that is arranged on a bottom 66a of the recess 66 wherein the coil 101 can be connected via a flexible conductor 104 to a further flexible connector 105 at the bottom of the lens barrel 60 that serves for electrically contacting the optical device 1.

Particularly, the configuration shown in FIG. 4 can be efficiently established by bringing up the flex tail 104 with the coil 101 etched as PCB 103 and gluing the PCB into the recess 66. Thereafter, the lens 10, with the piston 50 connected to the portion 22 of the membrane 20 is glued to lens barrel 60 so that the piston 50 is received by the recess 66. This allows one to create an extremely simplified electrical connection of the AF driver to the coil 101.

In the following, FIGS. 5 to 13 show different possible designs of the container 11 of the lens, particularly regarding the design of the lens shaper 40. Furthermore, FIGS. 14 to 17 particularly relate to the design of the actuator 100 (e.g. bi-directional micro pump) for moving the piston 50 in the opposite movement directions B, B′ so as to pump liquid L between the volumes V, R.

Particularly, according to the embodiment shown in FIGS. 5(A) and 5(B), the lateral wall structure 12 (e.g. formed out of a metal, a glass, or a plastic) of the container 11 of the lens 10 can be formed by a plate member 120 comprising a through-opening 121 for accommodating at least a portion of the lens volume V, and an opposing recess 122 for accommodating at least a portion of the reservoir volume R. Particularly, the plate member 120 is arranged between the cover element 30 (e.g. glass) and the membrane 20, wherein the membrane 20 is connected to the back side 12b of the plate member 120, and the cover element 30 is connected to the front side 12a of the plate member 120 so that the lens volume V is covered by the cover element 30 and the membrane 20, and the recess 122 is covered by the membrane 22 alone, particularly by said elastic wall portion 22 that forms an integral part of the membrane 20. However, the portion 22 may also be a separate part.

To define said curvature adjustable area 21 of the membrane 20, a lens shaper 40 is provided that is formed by a further plate member 40 (e.g. formed out of a metal, a glass, or a plastic), wherein the membrane 20 is arranged between the plate member 120 and the lens shaper 40. Particularly, the lens shaper 40 comprises a through-opening 41 delimited by a circular edge 42 that contacts the membrane 20 to define said area 21. In order to expose the wall portion 22 of the reservoir volume R, so that the piston 50 can interact with the reservoir volume R, the lens shaper 40 comprises a further through-opening 43. Here, the lens shaper 40 also functions as a distance holder to the lens barrel 60. Furthermore, the lens shaper 40 provides protection to the area 21 when it is in a convex state.

FIG. 6 shows an alternative embodiment, in which compared to FIG. 5 the position of the lens shaper 40 and the plate member 120 are interchanged, such that the membrane 20 is connected to the plate member 120 via the lens shaper 40, which means that know the lens shaper 40 is arranged between the membrane 20 and the plate member 120. Here, the through-opening 41 of the lens shaper 40 contributes to the lens volume V while the further through-opening 43 contributes to the reservoir volume R

FIG. 7 shows a modification of the embodiment shown in FIG. 5, wherein here the lens shaper 40 is formed by a ring member 40 (e.g. formed out of a metal, a glass, or a plastic) that comprises the through-opening 41 and the circular edge 42 for defining area 21 of the membrane 20. The further through-opening 122 of the plate member 120 is covered by the membrane 20, too (i.e. portion 22 is an integral part of the membrane 20).

Furthermore, FIG. 8 shows an embodiment of the lens 10, wherein here the lens shaper 40 (e.g. formed out of a metal, a glass, or a plastic) is formed by the plate member 120 itself, wherein the circular edge 42 of the lens shaper 40 is formed by a circular edge 42 of the through-opening 121 of the plate member 120. Furthermore, the recess 122 of the plate member 120 is formed as a through-opening. Here, both through-opening 121, 122 are covered on the front side 12a by the cover element 30 and on the back side 12b by the membrane 20

FIG. 9 shows a modification of the embodiment shown in FIG. 8, wherein the cover element 30 is a circular cover element 30 that covers the through-opening 121 of the plate member 120. To close also the recess (i.e. through-opening) 122, a further membrane 25 is provided which is arranged between the cover element 30 and the plate member 120. Thus, the reservoir volume is covered on the front side 12a as well as on the back side 12b by an elastic wall portion 25, 22.

As shown in FIG. 10, the container 10 of the lens 10 can also comprise a bent shape in principle to allow an arrangement with respect to the lens barrel 60 that minimizes installation space of the device 1.

For this, the container 11 comprises a first portion 11a comprising the lens volume V and a second portion 11b comprising the reservoir volume R, wherein the first portion 11a extends at an obtuse angle W with respect to the second portion 11b of the container 11 (cf. FIG. 10(A)). This allows the position of the container 11 shown in FIG. 10(B), wherein first portion 11a of the container is arranged on the face side 63 of the lens barrel so that said area 21 of the membrane 20 and the lens volume V face the rigid lenses 62 of the lens barrel, and wherein the second portion 11b of the container 11 is arranged laterally with respect to the lens barrel 60 and faces the lateral outer surface 65 of the lens barrel 60 in a direction perpendicular to the optical axis A of the lens 10 (or perpendicular to the optical axis A′ of the lens barrel 60).

Furthermore, as already mentioned above, in all lens designs a further membrane 25 can be arranged underneath the cover element (e.g. glass) to improve the index matching between liquid L and cover element 30

Furthermore, all plate members 120 discussed above can also be formed by stacking multiple flat elements on top of one another (e.g. instead of depth etching and/or injection molding of the plate member 120).

Furthermore, as indicated in FIG. 12, when the lens 10 is mounted (e.g. glued) onto the lens barrel 60 an air duct (e.g. air slit or air gap) is preferably provided in the lens region such that a deflection of the membrane 20 can occur (air exchange to compensate the overpressure or underpressure). The same holds for the housing 80 or recess 66. There can be one common air exchange in form of air ducts 84 and 85 of the housing 80 (or recess 66) so that the internal space 61 of the lens barrel can be vented via the internal space 85 of the housing (or via the recess 66) or an air duct 84 for the housing 80 (or recess 66) and a further air duct 67 to allow venting of the internal space 61 of the lens barrel. Particularly, all three air ducts 84, 86, 67 can be present. The configuration where merely the ducts 84, 86 are used has the advantage that less particles can enter the lens region (i.e. internal space 61 of the lens barrel 60).

Furthermore, FIG. 13 shows yet another embodiment of a design of the container 11 of the lens 10, which corresponds to a variant of the embodiment shown in FIG. 8. Particularly, according to FIG. 13, the plate member 120 is a printed circuit board, wherein said circular edge 42 of the lens shaper 40 is formed by an etched metal layer 44 (e.g. metal formed by or comprising copper) of the printed circuit board 120.

Etching of such a top (e.g. copper) layer results in a good quality lens shaper 40. The through-hole 121 of the plate member 120 can be drilled with a precise diameter, but does not need to be optical quality. This allows to build a very small, low cost and thin lens 10.

Alternatively, the lateral wall structure 12 or the plate member 120 or the further plate member 40 described herein can be formed out of or comprise: a metal, a plastic material, a polymer. Particularly, the lateral wall structure 12 or plate member 120 or further plate member 120 can be injection molded. Generally, the cover element 30 can be formed out of or can comprise: a glass, a plastic material, a polymer.

Furthermore, FIGS. 14 to 17 indicate different possible actuator designs that can be used with the present invention.

As shown e.g. in FIGS. 14 to 17, the optical device 1 comprises an actuator 100 that is configured to move the piston 50 of the lens 10 that is connected to said portion 22 (e.g. of membrane 20). Particularly, the actuator is configured to move the piston (e.g. along the optical axis A of the lens) in a first movement direction B such that the piston 50 pushes against the outside 22b of the wall portion 22 to pump liquid L from the reservoir volume R into the lens volume V so as to change (e.g. increase) the curvature of said area 21 of the membrane 20 of the lens 10 and therewith to change (e.g. decrease) the focal length of the lens 10. Furthermore, the actuator 100 is configured to move the piston 50 in an opposite second movement direction B′ such that the piston 50 pulls at the outside 22b of the wall portion 22 to pump liquid L from the lens volume V into the reservoir volume R so as to change the curvature of said area 21 of the membrane 20 of the lens 10 and therewith the focal length of the lens 10.

Particularly, as shown in FIGS. 14, 15, and 17, the piston 50 comprises a magnet 51 that is preferably connected to said wall portion 22 (e.g. portion of membrane 20) by a spacer 52 arranged between the magnet 51 and the wall portion 22 of the reservoir volume R.

Furthermore, as indicated in FIGS. 14, 15 and 17, the actuator 100 comprises an electrically conducting coil 101 configured to interact with the magnet 51 to move the piston 50 in said movement directions B, B′.

Particularly, the respective the coil 101 comprises an electrical conductor 102 which comprises windings 102a that extend around a winding axis C, wherein particularly the winding axis C extends parallel to the optical axis A of the lens and/or normal to the wall portion 22 of the container 11.

To achieve a very thin design, the coil 101 can be integrated into the plate member (PCB) 120, as shown in FIG. 13, wherein here the magnet 51 faces the coil 101 in the first movement direction B of the piston (50). Furthermore, the magnet 51 can comprise a magnetization M that extends parallel to the winding axis C (or parallel to the movement directions B, B′ or parallel to the optical axis A of the lens 10).

Furthermore, as described in conjunction with FIG. 4, the coil 101 can also be integrated into a printed circuit board 103 that is arranged on the bottom 66a of the recess 66 of the face side 63 of the lens barrel 60. Alternatively, it can be arranged on the bottom 66a of said recess 66, or it can be integrated into said bottom 66a.

Furthermore, in the embodiments shown in FIGS. 14 to 17, the lens 10 further comprises a housing 80 (the housing may also be formed by the recess 66 of the lens barrel as described herein), wherein the housing 80 comprises a bottom 80a facing the wall portion 22, and lateral wall 80b connecting the bottom 80a of the housing 80 to the container 11 of the lens 10.

Particularly, according to the embodiment shown in FIG. 14, the coil 101 is integrated into the bottom 80a of the housing 80 or arranged on the bottom 80a of the housing 80, such that the magnet 51 faces the coil 101 in the second movement direction B′ of the piston 50. Further, the magnet 51 comprises a magnetization M that extends parallel to the winding axis C of the coil 101. Depending on the direction of the electrical current I provided by the optical device 1 in the coil 101, the piston 50 moves (due to a dipole-dipole interaction between magnet and coil) either in the first movement direction B to pump liquid L from the reservoir volume R into the lens volume V (to e.g. give the area 21 a convex curvature) or in the second movement direction B′ in order to pump liquid L from the lens volume into the reservoir volume R (e.g. to reduce the convex curvature back to a flat state).

FIG. 15 shown an alternative embodiment, wherein (in contrast to FIG. 14) the coil 191 is 101 is integrated into the lateral wall 80b of the housing 80 or is arranged on the lateral wall 80b of the housing 80. Here, the magnet 51 is at least partially or completely arranged in a space 107 (e.g. air gap) surrounded by the windings 102a of the coil 101, wherein the magnet 51 can comprises a magnetization M that extends parallel to the winding axis C (or parallel to the optical axis A or parallel to the movement directions B, B′).

FIG. 17 shows a further variant of the embodiment shown in FIG. 15, wherein here, the magnet 50 is a ring magnet that is radially polarized, i.e. the respective magnetization M extends perpendicular to the winding axis C of the coil 101 (or perpendicular to the optical axis or movement directions B, B′).

FIG. 16 shows an alternative actuator design that does not need a magnet 51. Here, the actuator 100 comprises a member 200 formed out of a shape memory alloy for moving the piston 50, which member 200 connects the piston 50 to said housing 80 of the piston 50 (or to the lens barrel 60). Particularly, said member 200 comprises a state in which the member 200 causes the piston 50 to pull at the wall portion 22 by contracting the length of the shape memory alloy member (e.g. wire). In a bidirectional shape memory alloy configuration a push and pull of piston 50 is possible, i.e. instead of said member 200 the actuator may comprise a bidirectional shape memory alloy structure that is configured to push the piston 50 against the wall portion 22 or to cause the piston 50 to pull at the wall portion 22.

As further indicated in FIGS. 14 to 17, the container 11 can also form a stop 81 for the piston 50 in the first movement direction B of the piston 50. Further, the housing 80 can form a stop 82 for the piston 50 in the opposite second movement direction B′ of the piston 50. Further, the housing may also provide a stop 83 for the piston 50 in a direction perpendicular to said movement directions B, B′ of the piston 50. Due to these stops 81, 82, 83 the membrane 20/wall portion 22 can be protected against mechanical damage.

As illustrated in FIG. 18, which shows schematical plan views (A), (B) and (C) onto the lens barrel 60 of a mobile phone and a lens 10 arranged thereon, the design of the container 11 and particularly housing 80 of the lens 10 according to the present invention allows an arrangement of the lens 10 with respect to the lens barrel 60 that optimizes and maximizes the display area of a mobile phone.

In this regard FIG. 18(A) shows a configuration where the reservoir volume R is arranged on a corner region 60b of the lens barrel, while FIG. 18(B) shows a configuration where the reservoir volume R is arranged along an edge 60c of the lens barrel 60 in a centered fashion. Further, FIG. 18(C) shows a configuration where the reservoir volume R is arranged on the edge 60c of the lens barrel 60 but protrudes past the edge 60c from the lens barrel 60.

Furthermore, in general, the lens 10 (particularly to the coil 101 of the actuator 100 of the lens) can be electrically contacted by using a pin header, a flex cable (e.g. w/o dedicated connector) or half vias, particularly to directly connect the lens 10 to a camera module. According to a preferred variant shown in FIG. 19, the electrical connection can be brought down through an insert molded metal piece 106.

In other words, the lens barrel 60 can comprises an electrical connector 106 molded into the lens barrel 60 (e.g. by way of insert molding), wherein the electrical connector 106 protrudes out of the lens barrel 60 with two first end sections 106a that are soldered (or otherwise electrically connected) to the coil 101, and wherein particularly the electrical connector 106 protrudes out of the lens barrel 60 on an opposite side with two second end sections 106b that are e.g. soldered to electrical contacts arranged on a printed circuit board or a flexible connector 105.

Finally, FIG. 20 indicates that the shape of the reservoir volume R (and the piston 50) can be arbitrary and differ with respect to each other. Particularly, FIG. 20 shows different possible shapes of the reservoir and lens volume, wherein particularly the lens volume V can comprise a circular cross section (A), (B), while the reservoir volume R can deviate from a circular shape, and may comprise e.g. a square (A) or elliptical (B) cross section.

Furthermore, all actuators described herein that are based on an electrical coil can comprise a coil that can be wound coil or a PCB coil (e.g. a coil integrated into a PCB). Particularly in case of PCB coils, a driver can be directly soldered onto the PCB of the coil 101 and controlled using a digital signal, e.g. I2C, SPI etc.

1. An optical device, comprising a lens having an adjustable focal length, the lens comprising a container that encloses a lens volume and a reservoir volume that is connected to the lens volume, wherein the two volumes are filled with a transparent liquid, wherein the container further comprises a flat lateral wall structure having a front side and a back side, an elastically deformable and transparent membrane-, a transparent cover element, and an elastically deformable wall portion, wherein the membrane is connected to the back side of the lateral wall structure, wherein the cover element is connected to the front side of the lateral wall structure such that the lens volume is arranged between the cover element and the membrane, and wherein the wall portion is arranged adjacent the reservoir volume, and wherein the wall portion comprises an inside and an outside facing away from said inside, wherein the inside contacts the liquid residing in the reservoir volume, and wherein the lens further comprises a lens shaper that is connected to the membrane and defines an area of the membrane, which area has an adjustable curvature and contacts the liquid in the lens volume, and wherein the lens further comprises a movable piston connected to the outside of the wall portion and configured to act on said outside to pump liquid from the reservoir volume into the lens volume or from the lens volume into the reservoir volume so as to change the curvature of said area of the membrane and therewith the focal length of the lens.

2. The optical device according to claim 1, characterized in that the lateral wall structure comprises a plate member comprising a through-opening for accommodating at least a portion of the lens volume, and an adjacent recess for accommodating at least a portion of the reservoir volume.

3. The optical device according to claim 1, characterized in that the lens shaper comprises a through-opening delimited by a circular edge that contacts the membrane to define said area of the membrane.

4. The optical device according to claim 2, characterized in that the membrane is arranged between the plate member and the lens shaper.

5. The optical device according to claim 4, characterized in that the lens shaper is formed by a further plate member, wherein the lens shaper comprises a further through-opening to expose said wall portion; or wherein the lens shaper is formed by a ring member.

6. The optical device according to claim 3, characterized in that the membrane is connected to the plate member via the lens shaper, so that the lens shaper is arranged between the membrane and the plate member.

7. The optical device according to claim 6, characterized in that the lens shaper is formed by a further plate member, wherein the through-opening of the lens shaper accommodates a portion of the lens volume, and wherein the lens shaper comprises a further through-opening for accommodating a portion of the reservoir volume.

8. The optical device according to claim 3, characterized in that the lens shaper is formed by the plate member, wherein the circular edge of the lens shaper is formed by a circular edge of the through-opening of the plate member.

9. The optical device according to claim 8, characterized in that the plate member is a printed circuit board, wherein said circular edge of the lens shaper is formed by an etched metal layer of the printed circuit board.

10. The optical device according to claim 2, characterized in that the cover element is connected to the plate member so that the cover element covers the through-opening of the plate member and/or the recess of the plate member.

11. The optical device according to claim 2, characterized in that a further membrane is arranged between the plate member and the cover element.

12. The optical device according to claim 1, characterized in that the reservoir volume is arranged opposite the lens volume in a direction perpendicular to the optical axis of the lens.

13. The optical device according to claim 1, characterized in that the wall portion is formed by a portion of said membrane.

14. The optical device according to claim 1, characterized in that the container comprises a first portion surrounding the lens volume and a second portion surrounding the reservoir volume, wherein the first portion extends at an obtuse angle to the second portion.

15. (canceled)

16. The optical device according to claim 1, characterized in that the lens further comprises a housing connected to the container of the lens such that the housing encloses the piston together with the container.

17.-23. (canceled)

24. The optical device according to claim 1, characterized in that the optical device comprises a folding prism, wherein the container is connected to and/or arranged on a surface of the folding prism.

25. The optical device according to claim 1, characterized in that the optical device comprises an actuator wherein the actuator is configured to move the piston in a first movement direction such that the piston pushes against the outside of the wall portion to pump liquid from the reservoir volume into the lens volume so as to change the curvature of said area of the membrane of the lens and therewith the focal length of the lens, and/or wherein the actuator is configured to move the piston in a second movement direction such that the piston pulls at the outside of the wall portion to pump liquid from the lens volume into the reservoir volume so as to change the curvature of said area of the membrane of the lens and therewith the focal length of the lens.

26. The optical device according to claim 25, characterized in that the piston comprises a magnet.

27. (canceled)

28. The optical device according to claim 26, characterized in that the actuator comprises an electrically conducting coil configured to interact with the magnet to move the piston.

29. (canceled)

30. The optical device according to claim 9 and according to claim 28, characterized in that the coil is integrated into the plate member, wherein particularly the magnet faces the coil in the first movement direction of the piston, and wherein particularly the magnet comprises a magnetization that extends parallel to the winding axis.

31.-36. (canceled)
